(19) United States
(12) Patent Application Publication
(10) Pub. No.: US 2015/0317678 A1
(43) Pub. Date: Nov. 5, 2015

(54) SYSTEMS AND METHODS FOR SELECTING AND DISPLAYING ADVERTISEMENTS IN ASSOCIATION WTIH IMAGE BASED SEARCH RESULTS

(71) Applicants: Tao Huang, Cupertino, CA (US); Xinyu Tang, Cupertino, CA (US); Charles Chapin, San Jose, CA (US)

(72) Inventors: Tao Huang, Cupertino, CA (US); Xinyu Tang, Cupertino, CA (US); Charles Chapin, San Jose, CA (US)

(73) Assignee: GOOGLE INC., Mountain View, CA (US)

(21) Appl. No.: 13/344,724

(22) Filed: Jan. 6, 2012

(51) Int. Cl. G06Q 30/02

(52) U.S. Cl. CPC G06Q 30/0256

(57) ABSTRACT

A computer-implemented method that includes submitting, to a content server, a request for page content, receiving, from the content server, the page content, displaying, via a graphical user interface, the page content, determining whether a user has viewed the page content for at least a threshold period of time, sending to an advertisement server, in response to at least determining that the user has viewed the page content for at least the threshold period of time, an ad-request for an advertisement to be displayed in association with the page content, the ad request specifying keywords associated with the page content displayed, receiving, from the advertisement server, an advertisement based on the keywords, and displaying the advertisement via the graphical user interface.

### BACKGROUND OF THE INVENTION

1. Field of the Invention

This invention relates generally to providing content and more particularly to identifying and serving advertisement content.

2. Description of the Related Art

An advertisement may include promotional content that is intended to influence one or more persons' behavior. Advertisements are often used to persuade an audience to take some action with regard to products, services, ideals and so forth. For example an advertisement may be intended to cause a person to purchase a particular product or service. Advertisements are often presented via various forms of media, such as newspapers, magazines, television, radio, physical creatives (e.g., billboards, signs, posters, etc.), or electronic media (e.g., websites, search results, e-mails, text messages, etc.). With the advent of the Internet, many advertisement campaigns rely heavily on the use of on-line advertisements such as banner advertisements, videos, pop-up advertisements and so forth.

Advertisers typically pay a fee based on the number of times advertisements are displayed and/or based on how users interact with the advertisements. For example, where an advertiser employs an on-line advertisement, such as a banner ad displayed in a webpage, an advertiser may pay a fee of $0.10 to an advertisement provider for each time the ad is displayed or the number of times the ad is selected (e.g., clicked) by a user. In some instance, a website hosting the webpage displaying the ad may receive a portion of the payment from the advertiser. For example, the advertiser may provide a payment to the advertisement provider, and a portion of the payment may be distributed to the website owner to encourage the website owner to allow ads to be displayed on their webpages.

Unfortunately, the cost associated with advertising can be substantial. As a result, advertisers are generally interested in techniques to improve the effectiveness of their advertisements. In some instances, advertisers attempt target audiences that are more likely to be positively influenced by the advertisement. For example, advertisers may attempt to target users based on demographics of the user, and so forth. Although these techniques may be somewhat helpful, they may not enable advertisers to effectively regulate how and where their advertisements are being distributed.

### SUMMARY OF THE INVENTION

Various embodiments of methods and apparatus for serving content are provided herein. In some embodiments, provided is a computer-implemented method that includes submitting, to a content server, a request for page content, receiving, from the content server, the page content, displaying, via a graphical user interface, the page content, determining whether a user has viewed the page content for at least a threshold period of time, sending to an advertisement server, in response to at least determining that the user has viewed the page content for at least the threshold period of time, an ad-request for an advertisement to be displayed in association with the page content, the ad request specifying keywords associated with the page content displayed, receiving, from the advertisement server, an advertisement based on the keywords, and displaying the advertisement via the graphical user interface.

In some embodiments, provided is a computer-implemented method that includes displaying content via a graphical user interface, determining whether the content has been displayed for at least a threshold period of time, receiving advertisement content associated with the content displayed and displaying, in response to at least determining that the content has been displayed for at least the threshold period of time, the advertisement content via the graphical user interface.

In some embodiments, provided is a non-transitory computer readable storage medium having computer-executable program instructions stored thereon that are executable by a computer to cause displaying content via a graphical user interface, determining whether the content has been displayed for at least a threshold period of time, receiving advertisement content associated with the content displayed and displaying, in response to at least determining that the content has been displayed for at least the threshold period of time, the advertisement content via the graphical user interface.

In some embodiments, provided is a system including a processor, a memory and a module stored on the memory. The module is configured to be executed by the processor to cause displaying content via a graphical user interface, determining whether the content has been displayed for at least a threshold period of time, receiving advertisement content associated with the content displayed and displaying, in response to at least determining that the content has been displayed for at least the threshold period of time, the advertisement content via the graphical user interface.

### BRIEF DESCRIPTION OF THE DRAWINGS

FIG. 1 is a diagram that illustrates an advertising system in accordance with one or more embodiments of the present technique.

FIG. 2 is a flowchart that illustrates an exemplary method of proving advertising content in accordance with one or more embodiments of the present technique.

FIGS. 3A and 3B are diagrams illustrating interactions of various entities of the advertising system in accordance with one or more embodiments of the present technique

FIG. 4 is a diagram that illustrates an exemplary computer system in accordance with one or more embodiments of the present technique.

### DETAILED DESCRIPTION OF THE PREFERRED EMBODIMENTS

As discussed in more detail below, provided in some embodiments are systems and methods for requesting, selecting, serving and/or displaying on-line advertisements (e.g., ads) or similar creatives. In some embodiments, display of an advertisement or similar creative is delayed until after other content has been viewed for at least a given period of time (e.g., a threshold period of time). In certain embodiments, determining whether a user has viewed content for a threshold period of time may include determining whether the content has been rendered and/or displayed for at least the threshold period of time. In some embodiments, the other content displayed may include results of an image based search. In certain embodiments, keywords used for selecting an ad may be extracted based on the results of the image based search. In certain embodiments, the keywords may be included in an ad-request and/or may be used to select bids for an ad-auction to identify an advertisement to be displayed in association with the results of the image based search. In some embodiments, results of an image based search and/or ads served may provide for (e.g., instruct) display of the advertisements being delayed until after at least a portion of the results of the image based search have been rendered, displayed and/or viewed for at least a threshold period of time. In certain embodiments, instructions for delaying display of an advertisement are provided via delayed ad instructions and/or a delayed ad-tag.

Although certain embodiments are described in the context of image based searches, similar techniques may be employed in other contexts. For example, similar techniques for delaying the presentation of content may be employed to other types of searches/queries (e.g., keyword searches, voice based search queries and the like) and techniques for requesting and/or displaying content.

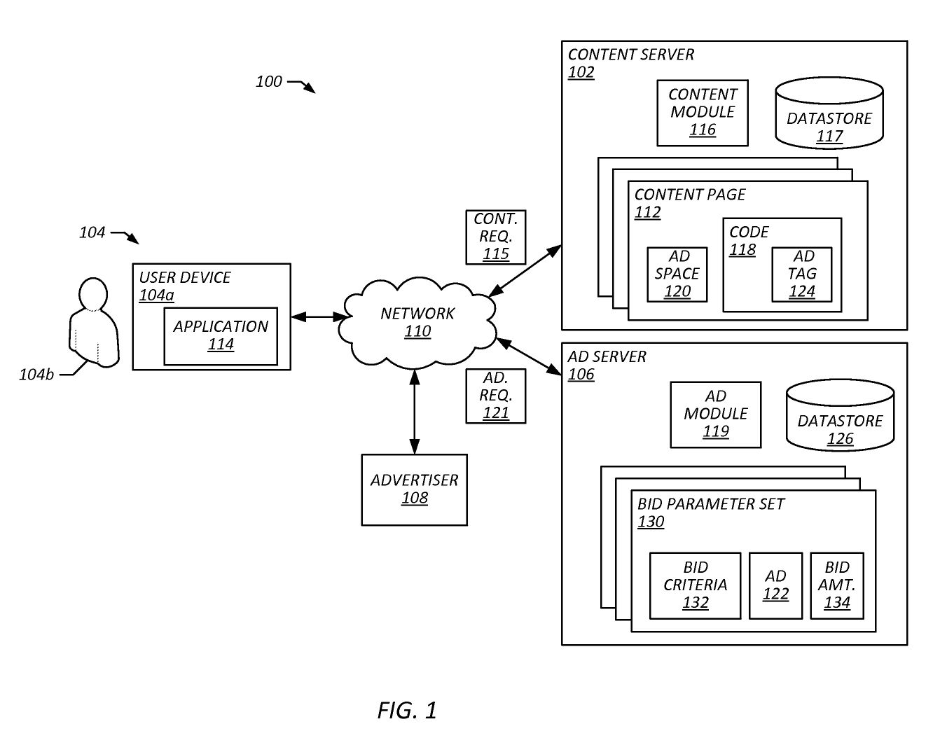

FIG. 1 is a diagram that illustrates an advertising system (“ad-system”) 100 in accordance with one or more embodiments of the present technique. Ad-system 100 may be implemented to present advertisements and/or other content to users. Ad-system 100 may include a content server 102, a user system 104, an ad-server 106 and an advertiser 108. In some embodiments, user system 104 may include a user device 104a employed by a user 104b for interacting with content. In some embodiments, advertiser 108 may include an advertiser device employed by an advertiser for interacting with content. In some embodiments, ad system 100 may serve or otherwise provide content (e.g., advertising content) for display to user 104b.

In some embodiments, entities of system 100 (e.g., content server 102, user device 104a, ad-server 106 and advertiser 108) may be communicatively coupled via a network 110. Network 110 may include may include any element or system that facilitates communications between various network entities/nodes of system 100. For example, network 110 may facilitate communication between content server 102, user device 104a, ad-server 106 and/or advertiser 108. Network 110 may include an electronic communication network, such as the Internet, a local area network (LAN), a wide area (WAN), a cellular communications network or the like. Network 110 may facilitate data exchange by way of packet switching using the Internet Protocol (IP). Network 110 may facilitate wired and/or wireless connectivity and communication. Network 110 may include a single network or combination of networks that facilitate communication between the entities of system 100.

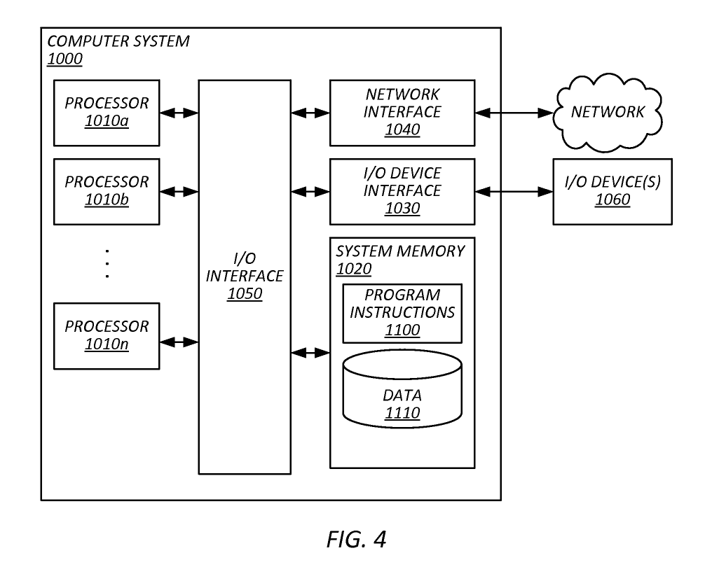

User device 104a may include any device capable of transmitting and/or receiving information via network 110. User device 104a may include a device employed by user 104b to interact with other entities/nodes coupled to network 110. User device 104a may include one or more of a personal computer (e.g., a desktop computer), a mobile computing device (e.g., a laptop computer), a cellular communication device (e.g., a cellular phone), a personal digital assistant (PDA), a media player/recorder, a game console, a television system, an audio system, a radio system, a navigation system, or the like. In some embodiments, user device 104a may include a wired or a wireless device. For example, user device 104a may include a cellular phone wirelessly connected to other devices via a cellular communications network. A wireless user device 104a may enable user 104b to access network 110, and entities connected thereto, from a variety of remote locations. User device 104a may include general computing components and/or embedded systems optimized with specific components for performing specific tasks. User device 104a may include a program/application that can be used to generate a request for content, to provide content, to render content, and/or to send/receive request to other devices via network 110. For example, user device 104a may employ a user application (e.g., an Internet web-browser application or similar application) 114. In some embodiments, application 114 may include a module including program instructions that are executable by a computer system to perform some or all of the functionality described with regard to user device 104a. User application 114 may be used to transmit and/or receive data and/or content via network 110, render data and/or content for display via user device 104a, and/or enable user interaction with data and/or content via user device 104a. User device 104a may include various input/output (I/O) interfaces. For example user device may include a graphical user interface (e.g., a display screen), an audible user interface (e.g., a speaker), printer, keyboard, a pointer device (e.g., mouse, trackball, touchpad, stylus), an audible interface (e.g., a microphone), or the like. In some embodiments, user device 104a may include a computer system similar to that of computer system 1000 described below with regard to at least FIG. 4.

Content server 102 may include an entity that provides content to various other entities of ad system 100. Content server 102 may be operated by a content publisher, such as a website provider. Content server 102 may host a content site, such as a website, a file transfer protocol (FTP) site, or other source of content accessible via network 110. Content server 102 may store or otherwise have access to content pages (e.g., webpages) 112. Content server 102 may serve content in response to receiving one or more content requests 115. For example, content server 102 may serve a given page 112 to application 114 of user device 104a in response to receiving a corresponding content request 115 for the given page 112 from application 114 of user device 104a. Certain embodiments are described in the context of a webpage although other embodiments may include any other form of content provided for presentation to a user. For example, content pages may include pages displayed by a search application employed by user device 104a.

Although content server 102 is represented by a single box in FIG. 1, content server 102 may include a single server or similar system, or a plurality of servers and/or similar systems. For example, content server 102 may include a plurality of different servers and/or similar systems that may be employed individually or in combination to perform some or all of the functionality described herein with regard to content server 102.

In some embodiments, content server 102 may include a content module 116. Content module 116 may include program instructions that are executable by a computer system to perform some or all of the functionality described with regard to content server 102. In some embodiments, content module 116 may be provided on a single server or similar system. In some embodiments, portions of content module 116 may be distributed to or otherwise employed by a plurality of different servers and/or similar systems of content server 102 or other entities of system 100.

In some embodiments, content server 102 may include or otherwise have access to a datastore 117. Datastore 117 may include a database or other memory location for storing data. In some embodiments, datastore 117 may store one or more of content pages 112 and/or other content employed by content server 102 for serving content request.

Content pages 112 may include source code 118 that can be rendered by application 114 of a user device to effectuate display of the content page to user 104b. For example, where content page 112 includes a webpage, source code 118 may include HTML code for the webpage that can be rendered by application (e.g., an Internet browser application) 114 of user device 104a to effectuate display of the webpage to user 104b via a graphical user interface of user device 104a.

In some embodiments, a given content page 112 may include or otherwise be associated with one or more ad-spaces 120. An ad-space 120 may include a location for the presentation of an ad/creative or similar content. In the context of on-line advertising, for example, ad-space 120 may include a location for the display of a banner advertisement, a pop-up window for an advertisement, or other location for the display of an on-line ad to be displayed to a user. In some embodiments, a content page may include any number of ad-spaces. For example, a given content page 112 may include three ad-spaces 120 for the display of three different ads.

In some embodiments, an ad to be displayed in a given ad-space may be provided by ad-server 106. For example, ad-server 106 may provide an ad 122 or similar content to be displayed in an ad-space 120 of a given content page 112.

Ad-server 106 may include an entity that provides advertisement content to various entities of ad system 100. Ad-server 106 may be operated by an ad publisher, such as an ad-publisher/network. Although ad-server 106 is represented by a single box in FIG. 1, ad-server 106 may include a single server or similar system, or a plurality of servers and/or similar systems. For example, ad-server 106 may include a plurality of different servers and/or similar systems that may be employed individually or in combination to perform some or all of the functionality described herein with regard to ad-server 106.

In some embodiments, ad-server 106 may include an ad module 119. Ad module 119 may include program instructions executable by a computer system to perform some or all of the functionality described with regard to ad-server 106. For example, ad module 119 may provide for receiving and storing bid-parameters, the receipt of ad-requests, processing of the ad-request, the selection of ads (e.g., via an ad-auction), serving of ads or similar content to requesting entities, and so forth. In some embodiments, ad module 119 may be provided on a single server or similar system. In some embodiments, portions of ad module 119 may be distributed to or otherwise employed by a plurality of different servers and/or similar systems of ad server 106 or other entities of system 100.

In some embodiments, ad server 106 may include or otherwise have access to a datastore 126. Datastore 126 may include a database or other memory location for storing data. In some embodiments, datastore 126 may store content employed by ad server 102 for serving ad-requests. For example, datastore 126 may include a database of bid-parameters, ads, and so forth.

In some embodiments, ad-server 106 serves ads or similar creatives in response to receiving a corresponding ad-request 121. For example, ad-server 106 may receive a given ad-request 121, process the given ad-request 121 to identify corresponding ad(s) to be served (e.g., via an ad-auction), and/or serve the corresponding ad(s) to the requesting entity. In some embodiments, ad-request 121 may specify various types of information such as attributes of the user to which the ad is to be displayed (e.g., demographics, recent search terms entered by the user), attributes of the content page 112 (e.g., words contained in the content page), attributes of a corresponding ad-space 120 (e.g., the type and/or location of the ad-space), a pricing model for the ad, and so forth.

In some embodiments, ad-server 106 may serve to content provider 102, ads that are to be displayed in association with ad-spaces of content pages served by content provider 102. For example, in response to receiving a given content request 115 for which a given content page 112 including an ad-space 120 is to be served, content server 102 may submit to ad-server 106, a corresponding ad-request 121 for an ad to be displayed in ad-space 120 of the given webpage 112. In response to ad-request 121, ad-server 106 may identify and serve a suitable ad 122 to content server 102. Content server 102 may assemble the given content page 112, including ad 122 to be presented in ad-space 120, and may serve the given content page 112 (including ad 122) to the requesting client (e.g., user device 104a) for display to user 104b.

In some embodiments, ad-server 106 may serve to user device 104a, ads that are to be displayed in association with ad-spaces of content pages to be displayed via user device 104a. For example, in response to receiving from user device 104a, a given content request 115 for a given content page 112, content server 102 may serve to user device 104a, a corresponding content page 112 including an ad-tag 124. Ad-tag 124 may include code that is embedded within source code 118 of the given content page 112 to act as a placeholder for advertisements to be presented in ad-space 120 of the given content page 112. When ad-tag 124 is encountered during rendering of content page 112 (e.g., execution of code 118 and/or code of ad-tag 124 by application 114), ad-tag 124 may cause user device 104a to submit to ad-server 106, a corresponding ad-request 121 for an ad to be displayed in ad-space 120 of the given webpage 112. In response to ad-request 121, ad-server 106 may identify and serve a suitable ad 122 to user device 104a. Application 114 may embed ad 122 into ad-space 120 and may provide for display of the given content page 112 (including the served ad 122 displayed in ad-space 120) via a graphical user interface of user device 104a.

In some embodiments, an ad may be served directly. For example, ad-server 106 may transmit content of a suitable ad 122 (e.g., ad-content) to content server 102 and/or user device 104a. In some embodiments, an ad may be served indirectly. For example, ad-server 106 may identify ad 122 to the requesting entity and/or redirect the requesting entity to a source (e.g., another server) from which content of ad 122 can be retrieved. For example, serving ad-request 121 may include transmitting an identity of ad 122 and/or a location of content for ad 122, and content server 102, user device 104a and/or application 114 may retrieve content for ad 122 from the given location (e.g., from another server, a remote storage location, a local memory, local cache, or the like).

Ad-publishers/networks (e.g., ad-publisher) may generate on-line ad revenue for an ad based on how an ad is served and/or how users interact with the ad. In some embodiments, revenue generated by ads is disbursed between various entities. For example, where an advertisement is displayed in an ad-space of a website's webpage, an ad-publisher may pay or otherwise direct a portion of the ad revenue collected from the advertiser to the website owner.

In some embodiments, various pricing models may be used to determine payments associated with ads. In a cost-per-impression (CPI) pricing model, advertisers may pay a given amount for each ad impression. An online ad impression may include a single appearance (e.g., display) of an ad on a content page (e.g., a webpage). In a cost-per-action (CPA) pricing model, advertisers may pay a fee upon the occurrence of each of one or more specified actions (e.g., click, purchase, lead, etc.) associated with the ad. Cost-per-action (CPA) pricing models may include various different pricing models, such as pay-per-click (PPC), cost-per-click-through (CPC), cost-per-sale (CPS), pay-per-lead (PPL), and other pricing models. In a pay-per-click (PPC) or cost-per-click-through (CPC) pricing model, advertisers may pay a fee in response to the ad being clicked/selected by a user. In a cost-per-sale (CPS) pricing model, advertisers may pay a fee in response to the ad being linked to a sale. For example, an advertiser may pay a given fee if a user navigates to the advertiser's website from an advertisement hyperlink and purchases an item on the advertiser's site. The above pricing models are intended to be exemplary. Embodiments may include various revenue generation techniques and pricing models.

In some embodiments, selection of one or more ads to be served to satisfy an ad-request may be provided via an auction (e.g., an “ad-auction”). An ad-auction may include submission/receipt of any number of bids associated with one or more ads intended to be presented in an ad-space associated with the ad-request. Execution of the ad-auction may identify winning bids and/or ads corresponding to the winning bids. The ads corresponding to the winning bids may be served to satisfy the ad-request. For example, in response to receiving a given ad-request 121 relating to ad-space 120, ad-server 106 may obtain bids relating to add space 120, conduct an ad-auction based on the obtained bids, identify a winning bid and, where ad 122 corresponds to the winning bid, serve ad 122 to satisfy ad-request 121.

In some embodiments, bids submitted to an ad-auction may be based on one or more bid parameters. In some embodiments, one or more related bid parameters may be defined by a bid-parameter-set 130. A given bid-parameter-set 130 may define conditions for submitting a bid to an ad-auction and/or ad content (e.g., an ad) to be provided in the instance the bid wins the ad-auction. Bid-parameter-sets 130 may be specified by one more advertisers. For example advertiser 108 may supply one or more bid-parameter-sets 130 to ad-server 106. Advertisers may provide bid-parameter-sets to regulate when their ads are eligible for being provided in response to an ad-request. For example, an advertiser 108 may specify a given bid-parameter-set 130 that enables bids corresponding to an ad 122 to be submitted to ad-auctions for ad-spaces under a given set of conditions, and inhibits bids corresponding to an ad 122 from being submitted to an ad-auction for an ad-space under another set of conditions.

A given bid-parameter-set 130 may include bid criteria 132, a bid amount 134, and/or a corresponding ad 122. Bid criteria 132 may define conditions for submitting a corresponding bid. When assessing bids to be submitted to an ad-auction for an ad-space, ad-server 106 may filter a plurality of bid-parameter-sets 130 based on their bid criteria 132 to identify one or more matching bid-parameter-sets 130 for which a corresponding bid should be submitted to the ad-auction. Ad-server 106 may submit to the ad-auction, bids corresponding to each of the matching bid-parameter-sets 130.

Bid criteria may specify one or more conditions that must exists for a corresponding bid to be submitted to an ad-auction. For example, if an ad-request is received for an ad-space that satisfies bid criteria 132 of a given bid-parameter-set 130, a bid corresponding to the given bid-parameter-set 130 may be submitted to the ad-auction for the ad-space. If, however, an ad-request is received for an ad-space that does not satisfy bid criteria 132 of a given bid-parameter-set 130, a bid corresponding to the given bid-parameter-set 130 may not be submitted to the ad-auction for the ad-space.

Bid criteria may specify a context of an ad-space that is required to submit a bid corresponding to the given bid-parameter-set. In some embodiments, bid criteria 132 may require that one or more given keywords must appear in a user initiated search and/or within the page containing the ad-space for a bid for the bid to be submitted. For example, where bid criteria 132 of a given bid-parameter-set 130 specifies that a user has submitted or otherwise engages in a search query specifying or otherwise related to the keyword “sports”, and ad-server 106 receives a given ad-request 121 for a given ad-space 120 to be displayed via user device 104a from which a query specifying or otherwise related to the keyword “sports” has been received, a bid corresponding to the given bid-parameter-set 130 may be submitted to an ad-auction for the given ad-space 120. Under the similar bid-criteria 132, where ad-server 106 receives a given ad-request 121 for a given ad-space 120 to be displayed via user device 104a from which a query specifying or otherwise related to the keyword “sports” has not been received, a bid corresponding to the given bid-parameter-set 130 may not be submitted to an ad-auction for the given ad-space 120.

As a further example, where bid criteria 132 of a given bid-parameter-set 130 specifies that a keyword of “sports” must be present on a page containing an ad-space for a bid to be submitted to an ad-auction for the ad-space, and ad-server 106 receives a given ad-request 121 for a given ad-space 120 of a given page 112 containing the word “sports”, a bid corresponding to the given bid-parameter-set 130 may be submitted to an ad-auction for the given ad-space 120. Under the similar bid-criteria 132, where ad-server 106 receives a given ad-request 121 for an ad-space 120 of a given page 112 that does not contain the word “sports”, a bid corresponding to the given bid-parameter-set 130 may not be submitted to an ad-auction for the given ad-space 120.

Bid criteria may be tailored to direct advertisements to a particular audience (e.g., a target audience). Advertisers may specify bid criteria to allow bid-submission to ad-auctions for ad-spaces that are more likely to be viewed by the intended audience and to restrict bid-submissions to ad-auctions for ad-spaces that are less likely to be viewed by the intended audience. For example, where advertiser 108 desires to place an ad related to sports, advertiser 108 may specify bid-parameter-sets 130 including bid criteria 132 limiting bids to webpages relating to sports, potentially increasing the likelihood of their advertisement being presented to a “sports” audience. Bid criteria may enable advertisers to specify a pricing model to enable an advertiser to control costs associated with on-line advertising. Such targeted bidding techniques may promote placement of ads in ad-spaces that may be more effective and/or inhibiting placement of ads in ad-spaces that may be less effective.

A bid amount 124 may specify or otherwise be indicative of a maximum monetary amount that the advertiser is willing to pay for a given ad-space. For example, a given bid-parameter-set 130 may specify a bid amount 134 of $0.10, indicating that advertiser 108 is willing to submit a maximum bid of $0.10 for a corresponding ad 122. In some embodiments, a bid amount may indicate a pricing model. For example, bid amount 124 may specify a maximum bid of $0.10 per impression, click-through, or the like.

An add 122 may include a creative that is to be presented in an ad-space upon the bid corresponding to the bid-parameter-set winning the ad-auction for the ad-space. For example, a given bid-parameter-set 130 may specify a single ad 122 that is to be served for presentation in the ad-space 120 in response to a bid corresponding to the given bid-parameter-set 130 winning the ad-auction for ad-space 120. A bid-parameter-set may specify multiple ads. For example, a given bid-parameter-set 130 may specify multiple ads 122 where one or more of the specified ads 122 are to be served for presentation in one or more ad-spaces 120 in response to a bid corresponding to the given bid-parameter-set 130 winning the ad-auction for one or more ad-spaces 120.

Ads may be provided by advertisers. For example, upon specifying a given bid-parameter-set 130 including bid criteria 132 and/or a bid amount 134, advertiser 108 may identify one or more ads 122 corresponding thereto. In some embodiments, an advertiser may provide the ad itself. For example, advertiser 108 may provide, to ad-server 106, a file including the content of ad 122. Ad 122 may be stored by ad-server 106 in datastore 126. Ad-server 106 may directly serve ad 122 to an entity when appropriate. For example, upon ad-server 106 receiving a given ad-request 121 for which ad 122 is to be provided, ad-server 106 may retrieve ad 122 from datastore 126 and transmit ad 122 to the requesting entity. In some embodiments, an advertiser may provide a reference to the ad (e.g., a location of the ad content corresponding to ad). For example, advertiser 108 may provide a file name of ad 122 and/or a location where ad 122 is stored (e.g., an ad-location), such as an address to a server on network. Ads may be indirectly served to an entity. For example, upon ad-server 106 receiving a given ad-request 121 for which ad 122 is to be provided, ad-server 106 may provide the file name and/or the ad-location (e.g., via a redirect) to the requesting entity. The served entity may use the ad-location to retrieve the corresponding content for ad 122.

Bid-parameter-sets may be obtained from a plurality of different advertisers. For example, ad-server 106 may receive one or more bid-parameter-sets 130 from any number of different advertisers 108. In some embodiments, an advertiser may submit a plurality of different bid-parameter-sets. For example advertiser 108 may submit a first bid-parameter-set 130 specifying first bid criteria 132, a first bid amount 134, a first ad 122, and a second bid-parameter-set 130 specifying second bid criteria 132, a second bid amount 134, a second ad 122. Some or all of the bid-parameter-sets received may be stored in a database (e.g., datastore 126).

Ad-server 106 may consider some or all of the bid-parameter-sets submitted when assessing suitable ads to be served in response to an ad-request. For example, upon receiving a given ad-request 121 for ad-space 120, ad-server 106 may assess bid criteria 132 for each bid-parameter-set 130 to determine, for each bid-parameter-set 130, whether or not a corresponding bid should be submitted to an ad-auction for ad-space 120. Ad-server 106 may determine whether or not a corresponding bid should be submitted to an ad-auction for ad-space 120 based on bid criteria 132 for the given bid-parameter-set 130. In some embodiments, ad-server 106 may filter-out bid-parameter-sets 130 having bid criteria 132 that does not match and/or otherwise conflicts with one or more characteristics of ad-space 120, thereby identifying bid-parameter-sets 130 (e.g., “matching bid-parameter-sets”) having bid criteria 132 that “matches” (e.g., that does not conflict with) characteristics of ad-space 120. Ad-server 106 may generate auction bids corresponding to the matching bid-parameter-sets 130. For example, where a given bid-parameter-set 130 matches, ad-server 106 may generate/submit a corresponding bid for the given bid-parameter-set 130 (e.g., a bid for bid amount 134) to an ad-auction for ad-space 120. Auction bids may be generated/submitted to the ad-auction for each of the matching bid-parameter-sets 130.

An ad-auction for an ad-space may include an automated auction to identify winning bids from the bids submitted to the auction. In some embodiments, winning bids may include auction bids of the highest bid amount. For example, a first bid specifying a bid amount of $0.20 per click-through may win over a second bid specifying a bid amount of $0.10 per click-through. In some embodiments, winning bids may include auction bids that are expected to generate the highest ad-revenue. For example, a first bid specifying a payment of $0.10 per click-through may win over a second bid specifying a payment of $0.20 per click-through where it is determined that the ad associated with the first bid is four times more likely to generate a click-though and is, thus, more likely to generate a higher overall ad-revenue.

Ad-server 106 may identify and/or serve ads corresponding to the winning auction bids. For example, where an auction bid corresponding to a given bid-parameter-set 130 is identified as a winning bid of the ad-auction for a given ad-space 120, ad-server 106 may serve ad 122 of the given bid-parameter-set 130 (e.g., to content server 102 and/or user device 104a). Ads corresponding to winning bids may be presented in one or more ad-spaces for display to a user. For example, ad 122 may be presented in the given ad-space 120 for display to user 104b. Application 114 may render content page 112 (including ad 122 in ad-space 120) for display to user 104b via a graphical interface of user device 104a.

In some embodiments, an ad-auction may include a plurality of winning bids. For example, a given ad-request 121 may include a request for three ads to be displayed in three separate ad-spaces 120 of a given page 112. Ad-server 106 may conduct an ad-auction in a manner similar to that discussed above, identifying three winning bids (e.g., a winning bid for each of the available ad-spaces). Ads corresponding to the three winning bids may be served for display in the three respective ad-spaces of the webpage. For example, three given ads 122 for three different bid-parameter-sets 130 corresponding to the winning bids may be served to fill three separate ad-spaces 120 of page 112.

In some embodiments, an ad selection process may be automated to facilitate rapid selection and/or serving of advertisement content. For example, in some embodiments, bid selection/filtering and/or the ad-auction may be executed by ad module 119 of ad-server 106. Bid selection/filtering and/or the ad-auction may be conducted within fractions of a second. In some embodiments, rapidly identifying suitable ads may enable ads to be served quickly, potentially reducing delay in presenting content to the user. For example, upon receiving, from application 114 of user device 104a, a given content request 115 request for a content page, content server 102 may submit the given ad-request 121 to ad-server 106 for an ad to be displayed in ad-space 120 of a given webpage 112, and ad-server 106 may execute corresponding bid selection/filtering and/or a corresponding ad-auction to quickly identify and serve a given ad 122 to content server 102, thereby allowing content server 102 to quickly assemble and serve the given content page 112 (including the given ad 122 for ad-space 120) to application 114 to be rendered for display to user 104b via a graphical interface of user device 104a. As a further example, upon application 114 rendering a given content page 112 with a given ad-tag 124, user device 104a may submit a corresponding ad-request 121 to ad-server 106 for an ad to be displayed in ad-space 120 of the given content page 112, ad-server 106 may execute the corresponding bid selection/filtering and/or a corresponding ad-auction to quickly identify and serve a given ad 122 to user device 104a, thereby allowing application 114 to quickly render the given content page 112 (including the given ad 122 for ad-space 120) for display to user 104b via a graphical interface of user device 104a.

In some embodiments, page content and/or corresponding advertisements or similar creatives may be provided in response to a search query based on a graphical image (e.g., an image based search). In some embodiments, a user may capture or otherwise obtain an image of an object for which the user desires to obtain corresponding information relating to the image. For example, a user may capture a photographic image of an object (e.g., a product, a place, a landmark, a logo, a business card, text, or the like). In some embodiments, a user may submit a search query based on the in the image (e.g., an image based search query). For example, a user may submit the photographic image to a search/content provider to obtain information relating to the object contained in the photograph. In some embodiments, the image based search query may be initiated and/or submitted via an image based search application provided on a user device. For example, an image may be acquired via a mobile device, such as a cellular phone including an integrated camera. The image may be processed by a local image based search application to serve the image based search request and/or generate and transmit a corresponding image based search request to a remote search provider (e.g., content server 102) for processing of at least a portion of the request.

In some embodiments, a local image based search application (or similar search application) and/or a remote provider may process the image and return resulting content related to the image. For example, where the imaged based search request includes the image, the search provider may process the image to identify an object (e.g., a product, a place, a landmark, a logo, a business card, text, or the like) represented in the photographic image, and may provide resulting content for display to the user. The resulting content may provide information (e.g., object information) associated with the object such as a name or other identifier of the object (e.g., object identifier) and/or other information relating to the object. For example, where the photographic image includes a photograph of a car, and the car is identified as the object, the object information may include the make, model, year, price, specifications, reviews, and/or other information related to the car.

In some embodiments, the resulting content may also include search results related to the object. For example, where the photographic images includes a photo of a car, and the car is identified as the object, the content page may include a plurality of search results related to the car (e.g., including hyperlinks to webpages associated with the car). In some embodiments, the search results may be similar to results that may be provided if the user were to initiate a traditional keyword search query including the object identifier as the search term. For example, where the photographic images includes a photo of a car identified as an object having an identifier of Chevrolet Corvette(r), the search results displayed may reflect results similar to those provided if a user were to submit a search query for “Chevrolet Corvette”. Thus, in some embodiments, resulting content may be identified via an automated search using keywords including or at least derived from an object identifier of an object identified via a photo submitted via an image based search query. In some embodiments, keywords may be derived from other portions of the object information for the object identified. For example, where the object information includes several references to “sports car”, search results displayed may reflect results similar to those provided if a user were to submit a search query for “sports car”.

In some embodiments, the results for an image based search may include ad content (e.g., one or more advertisements or similar creatives) to be presented along with the resulting content. For example, in addition to providing object information associated with the identified object, the content displayed to a user may include one or more ad-spaces populated with an advertisement. In some embodiments, the advertisement may be selected based at least in part on the image and/or the identified object. For example, where the photographic images includes a photo of a car identified as an object having an identifier of Chevrolet Corvette(r), a corresponding ad-request specifying the keyword(s) “Chevrolet Corvette” may be submitted to an ad-server. In response to the ad-request, the ad-server may identify and serve a suitable ad based at least in part on the keyword(s) “Chevrolet Corvette”. For example, the ad-server may conduct an ad-auction for the ad-space, wherein bids corresponding to bid-parameter sets specifying bid-criteria that is satisfied by the keyword(s) “Chevrolet Corvette” (or that otherwise does not conflict with the keyword(s) “Chevrolet Corvette”) are submitted to the ad-auction. Thus, an ad-auction for an ad-space to be displayed in association with the content providing details associated with an object identified via an image based search may be based on keywords including or at least derived from an object identifier of an object identified via an image submitted via an image based search query. In some embodiments, keywords may be derived from other portions of the object information for the object identified. For example, where the object information includes several references to “sports car”, search results displayed may reflect results similar to those provided if a user were to submit a search query for “sports car”. For example, the ad-server may conduct an ad-auction for the ad-space, wherein bids corresponding to bid-parameter sets specifying bid-criteria that is satisfied by the keyword(s) “sports car” (or that otherwise does not conflict with the keyword(s) “sports car”) are submitted to the ad-auction.

In some embodiments, ad content may be displayed at or near the time of displaying the resulting content. For example, an advertisement may be rendered for display at or near the time rendering the resulting content such that both of the resulting content and the advertisement may be effectively displayed to the user at the same time.

In some embodiments, display of ad content may be delayed for at least a given period of time relative to the display of the resulting content. For example, resulting content may be rendered and displayed, although rendering and/or display of an advertisement to be displayed in association with the resulting content may delayed for a given period of time such that the resulting content is displayed for a given period of time before the advertisement is displayed. The amount of time content is viewed by a user (or otherwise displayed) may be indicative of the user's level of interest in the displayed content. It may be determined that a user is more interested in displayed content where the user views or otherwise interacts with the displayed content for a longer period of time. Conversely, it may be determined that a user is less interested in displayed content where the user views or otherwise interacts with the displayed content for a shorter period of time. Accordingly, waiting for resulting content to be displayed for a threshold period of time prior to submitting an ad-request (or otherwise displaying an ad) may help to ensure that the user has an interest in the displayed content prior to displaying a corresponding ad. For example, a user uninterested in the resulting content may quickly navigate away from the display of the resulting content prior to display of the advertisement, thereby preventing execution of an ad impression that may otherwise be wasted on the uninterested user that is unlikely to even view the advertisement.

In some embodiments, an ad may not be displayed in an ad-space associated with a resulting content until the resulting content has been displayed for at least a given threshold period of time. For example, where a user has submitted an image based search query for which resulting content is displayed, an ad-request for an ad to be displayed in association with the resulting content may not be submitted and/or an advertisement associated with the resulting content may not be displayed until after the resulting content has been displayed for at least a given threshold period of time. Upon the resulting content being displayed for at least the given threshold period of time, an ad-request for an ad to be displayed in association with the resulting content may be submitted and/or an advertisement associated with the resulting content may be displayed.

Such delayed advertisements may reduce the number of ad impressions displayed to uninterested users and/or increase the likelihood that ad impressions are displayed to users having an interest in the resulting content and/or an ad related to the resulting content. For example, if a user were to quickly navigate away from resulting content including details of a Chevrolet Corvette®, it may be determined that the user is not interested in the Chevrolet Corvette® based on the lack of the user viewing or otherwise interacting with the resulting content and, thus, serving an ad based on the keywords “Chevrolet Corvette” (e.g., an ad targeted to potential purchasers of a Chevrolet Corvette®) may not be warranted as the user may have little to no interest in the ad. In contrast, however, were resulting content including details of a Chevrolet Corvette® to be viewed by a user and/or displayed for an extended period of time (e.g., a period of time exceeding a given threshold period of time), it may be determined that the user is interested in the Chevrolet Corvette(r) based on the extended interaction with (e.g., viewing of) the content page and, thus, serving an ad based on the keyword Chevrolet Corvette(r) (e.g., an ad targeted to potential purchasers of a Chevrolet Corvette®) may be warranted as the user may have high interest in the ad. In such an embodiment, an ad-request may be submitted to ad-server 106.

In some embodiments, delaying ad-request or otherwise delaying display of ad content may help to improve device performance as it may reduce the number of ad-request and the amount of data rendered and/or processed. For example, where a user navigates away from content results prior to the content results being viewed or otherwise displayed for the threshold period of time, a corresponding ad-request may not be submitted and/or the corresponding ad may not be rendered for display.

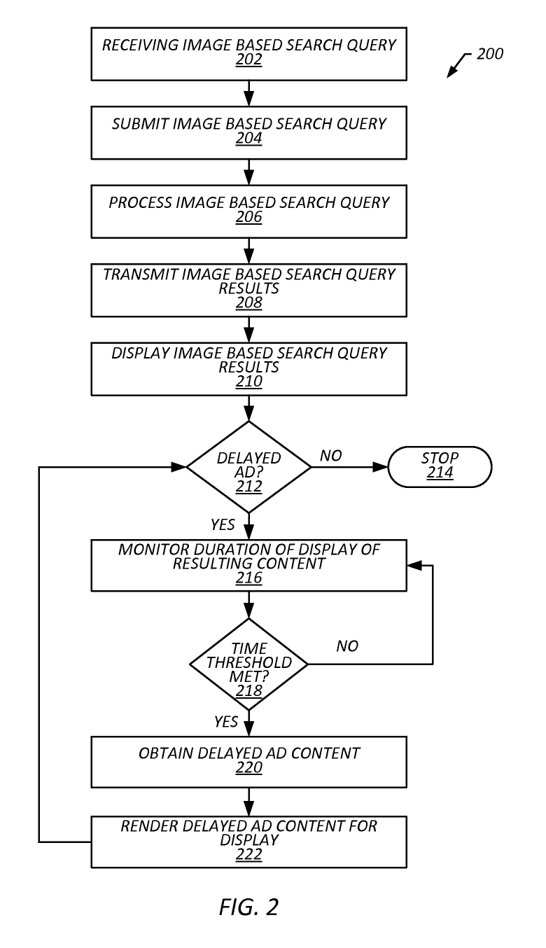

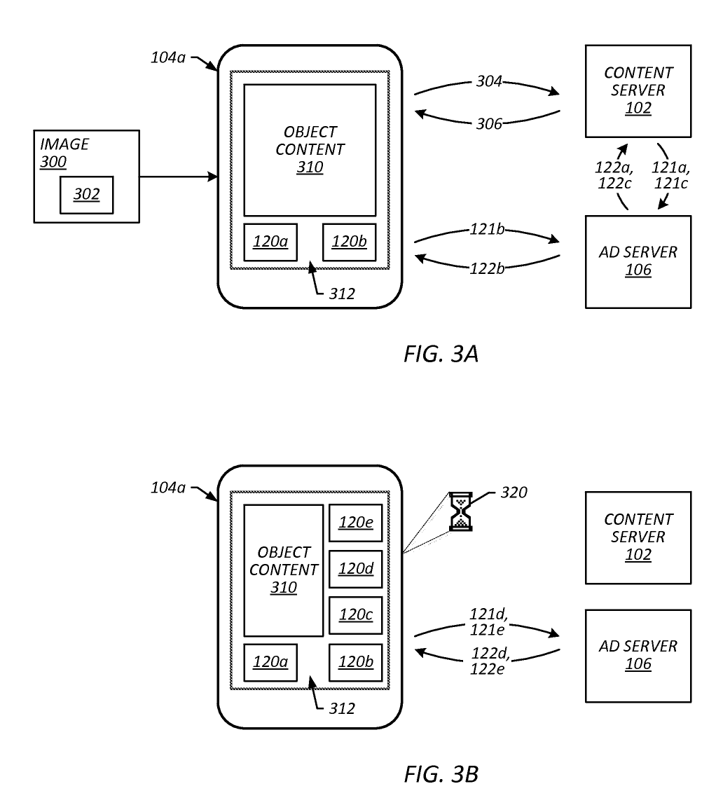

FIG. 2 is a flowchart that illustrates an exemplary method 200 of proving advertising content in accordance with one or more embodiments of the present technique. FIGS. 3 A and 3B include diagrams illustrating interactions of various entities of system 100. FIGS. 3A and 3B may correspond to the techniques describe with regard to method 200.

Method 200 may include receiving an image based search query, as depicted at block 202. Receiving an image based search query may include receiving a search query for information related to a given image. For example, an image based search query 301 may include an image 300 of an object 302 object (e.g., person, place, landmark, text, etc.) for which a user desires to obtain corresponding information. Image 300 may include a graphical image, such as a digital photograph including a graphical representation of object 302. For example, image 300 may include a digital photograph depicting an object 302 such as a Chevrolet Corvette®. In some embodiments receiving an image based search query may include receiving and/or storing image 300. For example, image 300 may be acquired via an image capture device such as an embedded camera of user device 104a.

Method 200 may include submitting an image based search query, as depicted at block 204. In some embodiments, submitting an image based search query may include transmitting an image based search query to a search provider. For example, user device 104a transmitting an image based search query 304 to content server 102. In some embodiments, image based search query 304 may include image 300 of object 302 and/or a request to provide content corresponding thereto (e.g., content corresponding to object 302 of image 300).

Method 200 may include processing the image based search query, as depicted at block 206. In some embodiments, processing the image based search query may include processing image 300 to identify one or more objects (e.g., object 302) represented by image 300. For example, where image 300 includes a digital photograph depicting a Chevrolet Corvette®, content server 102 may process image 300 to identify one or more objects 302 including the Chevrolet Corvette®.

Processing the image based search query may include generating, identifying and/or obtaining resulting content 306 to be served to user device 104a. In some embodiments, resulting content 306 may include object content 310. Object content 310 may include object information related to the one or more objects identified. For example, processing the image based search query may include obtaining object information related to the Chevrolet Corvette(r). In some embodiments, object information may include a name or other identifier of the object (e.g., object identifier) and/or other information relating to the object. For example, where image 300 includes a photograph of a Chevrolet Corvette(r), object information may include information related to the car, such as the make (e.g., Chevrolet), model (e.g., Corvette), year (e.g., 2011), pricing information (e.g., $49,000), specifications (e.g., 505 horsepower), reviews, images (e.g., photographs) and/or other information related to the car. In some embodiments, object information may include a plurality of search results related to the object. For example, where object 302 is identified as a Chevrolet Corvette®, the search results may include hyperlinks to the Chevrolet Corvette® manufacture's website, Corvette enthusiasts' websites, and so forth.

In some embodiments, resulting content 306 may include advertisement (ad) content 312. Ad content 312 may include one or more advertisements or similar creative to be served to and/or displayed by user device 104a. Ad content 312 may include one or more ads to be displayed in association with object content 310. For example, the resulting content 306 may include a content page 112 including first ad-space 120a and a second space 120b in which the first and second ads are to be displayed, respectively. In some embodiments, one or more of the ad-spaces may be populated with an ad (e.g., an ad may be displayed in the given ad-space) at or near the time of resulting content 306 (e.g., object content 310) being rendered and/or displayed at user device 104a. For example, where first ad-space 120a is to be populated at or near the time of rendering and/or display of object content 310, content server 102 may submit to ad-server 106, a first ad-request 121a for a suitable ad to be displayed in first ad-space 120a. In response to receiving from ad-server 106 a first ad 122a corresponding to first ad-request 121a, content server 102 may embed first ad 122a into resulting content 306 such that first ad 122a is displayed in first ad-space 120a upon rendering and/or display of object content 310.

In some embodiments, where second ad-space 120b is to be populated at or near the time of rendering and/or display of object content 310, content server 102 may embed within resulting content 306 an ad-tag (e.g., an ad-tag 124) that, when executed, causes user device 104a to submit to ad-server 106, a second ad-request 121b for a suitable ad (e.g., ad 122b) to be displayed in the second ad-space 120b upon rendering and/or display of object content 310.

In some embodiments, one or more of the ad-spaces associated with resulting content 306 may be populated with an ad after resulting content 306 (e.g., object content 310) has been displayed for at least a threshold period of time. For example, where a third ad-space 120c is to be populated with an ad after some or all of object content 310 has been rendered and/or displayed for at least a threshold period of time (e.g., five seconds), content server 102 may submit to ad-server 106, a third ad-request 121c for a suitable ad to be displayed in third ad-space 120c. In response to receiving from ad-server 106, a third ad 122c corresponding to third ad-request 121c, content server 102 may embed third ad 122c into resulting content 306. In some embodiments, resulting content 306 may include delayed ad instructions (e.g., embedded into source code 118) to delay display of third ad 122c until some or all of object content 310 has been rendered and/or displayed for at least the threshold period of time. The delayed ad instructions may provide for third ad 122c not being displayed in third ad-space 120c initially (e.g., third ad 122c is not displayed in third ad-space 120c upon rendering and/or display of object content 310 at user device 104a), and display of the third ad 122c after some or all of object content 310 has been rendered and/or displayed for at least the threshold period of time.

In some embodiments, where a fourth ad-space is to be populated with an ad after some or all of resulting content 306 (e.g., object content 310) has been rendered and/or displayed for at least a threshold period of time, content server 102 may embed a given delayed-ad-tag (e.g., an ad-tag 124) that, when executed, causes user device 104a to, after some or all of object content 310 has been displayed for at least a threshold period of time (e.g., six seconds), submit to ad-server 106, a fourth ad-request 121d for a suitable ad 122d to be displayed in fourth ad-space 120d. In some embodiments, the delayed ad-tag may specify a threshold time (e.g., six seconds), and when executed may initiate/operate a timer to monitor the period of time for which some or all of object content 310 has been rendered and/or displayed, and/or to initiate submission of a fourth ad-request 121d for a suitable ad to be displayed in the fourth ad-space 120d upon determining (e.g., based on the timer) that some or all of object content 310 has been rendered and/or displayed for at least the threshold period of time specified.

In some embodiments, application 114 may include delayed ad instructions that, when executed, cause user device 104a to, after some or all of resulting content 306 (e.g., object content 310) has been rendered and/or displayed for at least a threshold period of time (e.g., seven seconds), submit to ad-server 106, a fifth ad-request 12 le for a suitable ad to be displayed in a fifth ad-space 120e. In some embodiments, the delayed ad instructions may specify a threshold time (e.g., seven seconds), and when executed may initiate/operate a timer to monitor the period of time for which some or all of object content 310 has been rendered and/or displayed, and/or initiate submission of a fifth ad-request 121e for a suitable ad 122e to be displayed in fifth ad-space 120e upon determining (e.g., based on the timer) that some or all of object content 310 has been rendered and/or displayed for at least the threshold period of time specified.

In some embodiments, an ad-request (e.g., ad-request 121a-121d) may specify keywords associated with one or more objects identified from image 300. For example, where object 302 is identified as a Chevrolet Corvette(r), any of ad-request 121a-121d may specify keywords relating to the object identifier (e.g., “Chevrolet” and/or “corvette”) and or other object information (e.g., “sports” and/or “car”) such that an ad-auction for a suitable ad to be displayed in the associated ad-space may be based on keywords determined via processing of image 300 and/or object 302 of an image based search query.

Method 200 may include transmitting image based query results, as depicted at block 208. In some embodiments, transmitting image based query results may include content server 102 transmitting resulting content 306 (generated at block 206) to user device 104a. In some embodiments, resulting content 306 may include a content page (e.g., webpage) for the display of object content 310 and/or ad content 312 (e.g., some or all of ads 122a-122e).

Method 200 may include displaying image based search query results, as depicted at block 210. Displaying image based search query results may include executing, rendering and/or otherwise processing resulting content 306 to effectuate display of resulting content 306 to user 104b via a graphical user interface of user device 104a. In some embodiments, display of resulting content 306 may include display of object content 310 and/or ad content 312.

In some embodiments, some or all of ad content 312 may not be displayed until it has been determined that some or all of object content 310 has been rendered, displayed and/or viewed for at least a corresponding threshold period of time.

In some embodiments, displaying image based search query results includes initially displaying some or all of object content 310. For example, upon receipt of resulting content 306 by user device 104a, application 114 may render object content 310 for display via a graphical user interface of user device 104a, as depicted in FIG. 3A. Where object 302 is identified as a Chevrolet Corvette(r) object content 310 may include related information, such as the make (e.g., Chevrolet), model (e.g., Corvette), year (e.g., 2011), pricing information (e.g., $49,000), specifications (e.g., 505 horsepower), reviews, images (e.g., photographs), links to Chevrolet Corvette(r) manufacture's website, Corvette enthusiasts websites, and/or other information related to the car.

In some embodiments, displaying image based search query results may include initially displaying some or all of ad content 312 intended to be displayed at or near the time of rendering and/or displaying of object content 310. For example, upon receipt of resulting content 306 by user device 104a, application 114 may render ad 122a for display in ad-space 120a as depicted in FIG. 3A. In some embodiments, upon receipt of resulting content 306 by user device 104a, application 114 may execute an ad-tag 124, resulting in submission of ad-request 121b to ad-server 106, ad-server 106 may provide corresponding ad 122b at or near the time of rendering and/or displaying of object content 310, and/or application 114 may render ad 122b for display in ad-space 120b at or near the time of rendering and/or displaying of object content 310 as depicted in FIG. 3A.

In some embodiments, displaying image based search query results includes monitoring the duration of the rendering, display and/or viewing of object content 310 and/or providing for the delayed display of ad content 312 intended to be displayed upon object content 310 being rendered, displayed and/or viewed for at least a corresponding threshold period of time.

Method 200 may include determining whether or not ad-content (e.g., delayed ad-content) is to be displayed upon object content 310 being rendered, displayed and/or viewed for at least a given threshold period of time, as depicted at block 212. In some embodiments, whether or not there is delayed ad-content may be based on the resulting content 306. For example, it may be determined that there is delayed ad-content where resulting content 306 includes delayed ad instructions, resulting content 306 includes one or more delayed ad-tags and/or application 114 includes delayed ad instructions. It may be determined that there is no delayed ad-content where resulting content 306 does not include delayed ad instructions, resulting content 306 a delayed ad-tag and/or application 114 does not include delayed ad instructions.

Method 200 may terminate where it is determined that there is no delayed ad content, as depicted at block 214. For example, resulting content 306 may be rendered and displayed as depicted in FIG. 3A. Method 200 may include processing and/or providing for the display of the delayed ad content, as depicted at blocks 216-222, where it is determined that there is delayed ad content at block 212.

Method 200 may include monitoring a duration of the display of resulting content, as depicted at block 216. In some embodiments, monitoring the duration of the display of resulting content may include initiating a timer at or near the time of rendering and/or displaying of object content 310. For example, upon rendering/executing some or all of resulting content 306 and/or displaying some or all of object content 310, application 114 of user device 104a may initiate a timer 320 to provide an indication of the amount of time that some or all of resulting content 306 and/or displaying some or all of object content 310 has been rendered and/or displayed to user 104b via the graphical user interface of user device 104a. Timer 320 may be monitored to determine if a threshold period of time corresponding to one or more delayed ads has been met, as depicted at block 218. If the time threshold has been met, corresponding ad content may be obtained and rendered for display as depicted at blocks 220 and 222. For example, where delayed ad instruction provide for third ad-space 120c to be populated with ad 122c after some or all of object content 310 has been displayed for five seconds and timer 320 indicates that some or all of object content 310 has been displayed for at least five seconds, ad 122c may be rendered for display in ad-space 120c, as depicted in FIG. 3B.

Where a delayed ad-tag provides for fourth ad-space 120d to be populated with an ad 122d after some or all of object content 310 has been displayed for six seconds and timer 320 indicates that some or all of object content 310 has been displayed for at least six seconds, ad-request 121d may be submitted to and processed by ad-server 106 (e.g., via an ad-auction), ad-server 106 may serve ad 122d to user device 104b, and ad 122d may be rendered for display in ad-space 120d, as depicted in FIG. 3B.

Where application 114 includes delayed ad instructions that provide for fifth ad-space 120e to be populated with an ad 122e after some or all of object content 310 has been displayed for seven seconds and timer 320 indicates that some or all of object content 310 has been displayed for at least seven seconds, ad-request 12 le may be submitted to and processed by ad-server 106 (e.g., via an ad-auction), ad-server 106 may serve ad 122e to user device 104b, and ad 122e may be rendered for display in ad-space 120e, as depicted in FIG. 3B.

In some embodiments, delayed ad-content may be displayed in place of content already displayed. For example, application 114 may include delayed ad instructions that provide for first ad-space 120a to initially be populated with a first that (e.g., ad 122a), and to be populated with another ad (e.g., ad 122e replacing ad 122a) after some or all of object content 310 has been displayed for seven seconds and timer 320 indicates that some or all of object content 310 has been displayed for at least seven seconds. Similar techniques may be employed for other ad-spaces. In some embodiments, delayed ads may be subsequently replaced by other delayed ads.

In some embodiments, once all of the delayed ad content has been displayed, it may be determined that there is no pending delayed ad content, at block 212, and method 200 may terminate, as depicted at block 214.

In some embodiments, if the resulting content was not displayed for the threshold period of time, corresponding delayed ad content may not be rendered and/or displayed. For example, were user 104b to navigate away from a page displaying object content 310, as depicted in FIG. 3A, before timer 320 reached five seconds, ads 121c, 121d and 121e may not be rendered/displayed in ad-spaces 120c, 120d and 120e.

It will be appreciated that method 200 is an exemplary embodiment of a method employed in accordance with techniques described herein. Method 200 may be may be modified to facilitate variations of its implementations and uses. Method 200 may be implemented in software, hardware, or a combination thereof. Some or all of method 200 may be implemented by application 114. The order of method 200 may be changed, and various elements may be added, reordered, combined, omitted, modified, etc.

Exemplary Computer System

FIG. 4 is a diagram that illustrates an exemplary computer system 1000 in accordance with one or more embodiments of the present technique. Various portions of systems and methods described herein, may include or be executed on one or more computer systems similar to system 1000. For example, content server 102, user device 104a, ad-server 106 and/or advertiser 108 described herein may include a configuration similar to at least a portion of computer system 1000. Further, methods/processes/applications/modules described herein may be executed by one or more processing systems similar to that of computer system 1000.

Computer system 1000 may include one or more processors (e.g., processors 1010a-1010n) coupled to system memory 1020, an input/output I/O device interface 1030 and a network interface 1040 via an input/output (I/O) interface 1050. A processor may include a single processor device and/or a plurality of processor devices (e.g., distributed processors). A processor may be any suitable processor capable of executing/performing instructions. A processor may include a central processing unit (CPU) that carries out program instructions to perform the basic arithmetical, logical, and input/output operations of computer system 1000. A processor may include code (e.g., processor firmware, a protocol stack, a database management system, an operating system, or a combination thereof) that creates an execution environment for program instructions. A processor may include a programmable processor. A processor may include general and/or special purpose microprocessors. A processor may receive instructions and data from a memory (e.g., system memory 1020). Computer system 1000 may be a uni-processor system including one processor (e.g., processor 1010a), or a multi-processor system including any number of suitable processors (e.g., 1010a-1010n). Multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. Processes and logic flows described herein may be performed by, and apparatus can also be implemented as, special purpose logic circuitry, e.g., an FPGA (field programmable gate array) or an ASIC (application specific integrated circuit). Computer system 1000 may include a computer system employing a plurality of computer systems (e.g., distributed computer systems) to implement various processing functions.

I/O device interface 1030 may provide an interface for connection of one or more I/O devices 1060 to computer system 1000. I/O devices may include any device that provides for receiving input (e.g., from a user) and/or providing output (e.g., to a user). I/O devices 1060 may include, for example, graphical user interface displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 and/or data 1040. Program instructions 1100 may be executable by a processor (e.g., one or more of processors 1010a-1010n) to implement one or more embodiments of the present technique. Instructions 1100 may include modules of computer program instructions for implementing one or more techniques described herein with regard to various processing modules. Program instructions may include a computer program (also known as a program, software, software application, script, or code). A computer program may be written in any form of programming language, including compiled or interpreted languages, or declarative/procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier and/or a non-transitory computer readable storage medium having program instructions stored thereon. A tangible program carrier may include a propagated signal and/or a non-transitory computer readable storage medium. A propagated signal may include an artificially generated signal (e.g., a machine generated electrical, optical, or electromagnetic signal) having encoded information embedded therein. The propagated signal may be transmitted by a suitable transmitter device to and/or received by a suitable receiver device. A non-transitory computer readable storage medium may include a machine readable storage device, a machine readable storage substrate, a memory device, or any combination thereof. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices and/or software that may perform or otherwise provide for the performance of the techniques described herein. For example, computer system 1000 may include a desktop computer, a laptop computer, a tablet computer, a server device, a client device, a mobile telephone, a personal digital assistant (PDA), a mobile audio or video player, a game console, a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

1-20. (canceled)

21. A computer implemented method of presenting advertisements in response to an image-based search query, the method comprising:
receiving, by one or more computing devices, a search query from a client device expressed as an image;
identifying, by the one or more computing devices, an object in the received image;
selecting, by the one or more computing devices, an advertisement responsive to the identified object in the received image;
identifying, by the one or more computing devices, search results responsive to the identified object the search results corresponding to a plurality of hyperlinks to websites including content associated with the identified object; and
sending, by the one or more computing devices, delayed-advertisement instructions that, when executed on the client device, cause the client device to perform operations comprising:
determining that the search results have been displayed for more than a threshold duration of time; and
displaying the selected advertisement alongside the search results when it is determined that the search results have been displayed for more than the threshold duration of time.

22. (canceled)

23. The method of claim 21, wherein determining that the search results have been displayed for more than a threshold duration of time comprises:
initiating a timer upon rendering or display of the search results; and
monitoring the timer to determine whether the search results have been displayed for at least the threshold duration of time.

24. The method of claim 21, wherein displaying the selected advertisement alongside the search results comprises displaying the advertisement in place of at least a portion of a webpage displaying the search results.

25. The method of claim 21, wherein displaying the selected advertisement alongside the search results comprises displaying the selected advertisement in place of a previously displayed advertisement.

26. The method of claim 21, wherein the delayed-advertisement instructions, when executed on the client device, cause the client device to perform further operations comprising:
sending a request for the selected advertisement when it is determined that the search results have been displayed for more than the threshold duration of time.

27. The method of claim 26, wherein selecting an advertisement responsive to the identified object is performed after sending the instructions to the client device and in response to the request for an advertisement from the client device.

28. The method of claim 21, wherein the image is a digital image captured by a camera of the client device.

29. A tangible, non-transitory, machine-readable medium storing code that when executed by a data processing apparatus cause the data processing apparatus to perform operations comprising:
receiving a search query from a client device expressed as an image;
identifying an object in the received image;
selecting an advertisement responsive to the identified object in the received image;
identifying search results responsive to the identified object, the search results corresponding to a plurality of hyperlinks to websites including content associated with the identified object; and
sending delayed-advertisement instructions that, when executed on the client device, cause the client device to perform operations comprising:
determining that the search results have been displayed for more than a threshold duration of time; and
displaying the selected advertisement alongside the search results when it is determined that the search results have been displayed for more than the threshold duration of time.

30. (canceled)

31. The medium of claim 29, wherein determining that the search results have been displayed for more than a threshold duration of time comprises:
initiating a timer upon rendering or display of the search results; and
monitoring the timer to determine whether the search results have been displayed for at least the threshold duration of time.

32. The medium of claim 29, wherein displaying the selected advertisement alongside the search results comprises displaying the advertisement in place of at least a portion of a webpage displaying the search results.

33. The medium of claim 29, wherein displaying the selected advertisement alongside the search results comprises displaying the selected advertisement in place of a previously displayed advertisement.

34. The medium of claim 29, wherein the delayed-advertisement instructions, when executed on the client device, cause the client device to perform further operations comprising:
sending a request for the selected advertisement when it is determined that the search results have been displayed for more than the threshold duration of time.

35. The medium of claim 34, wherein selecting an advertisement responsive to the identified object is performed after sending the instructions to the client device and in response to the request for an advertisement from the client device.

36. The medium of claim 29, wherein the image is a digital image captured by a camera of the client device.

37. A system, comprising:
one or more processors; and
memory, in communication with the processors, and storing instructions that when executed by the processors cause operations comprising:
receiving a search query from a client device expressed as an image;
identifying an object in the received image;
selecting an advertisement responsive to the identified object in the received image;
identifying search results responsive to the identified object, the search results corresponding to a plurality of hyperlinks to websites including content associated with the identified object; and
sending delayed-advertisement instructions that, when executed on to the client device, cause the client device to perform operations comprising:
determining that the search results have been displayed for more than a threshold duration of time; and
displaying the selected advertisement alongside the search results when it is determined that the search results have been displayed for more than the threshold duration of time.

38. (canceled)

39. The system of claim 37, wherein determining that the search results have been displayed for more than a threshold duration of time comprises:
initiating a timer upon rendering or display of the search results; and
monitoring the timer to determine whether the search results have been displayed for at least the threshold duration of time.

40. The system of claim 37, wherein displaying the selected advertisement alongside the search results comprises displaying the advertisement in place of at least a portion of a webpage displaying the search results.

41. The method of claim 21, wherein the threshold duration of time is selected as a duration of time across which a user of the client device is likely to view the search results based on the user's interest in the content associated with the search results.

42. The medium of claim 29, wherein the threshold duration of time is selected as a duration of time across which a user of the client device is likely to view the search results based on the user's interest in the content associated with the search results.

43. The system of claim 375 wherein the threshold duration of time is selected as a duration of time across which a user of the client device is likely to view the search results based on the user's interest in the content associated with the search results.
